(19) United States
(12) Patent Application Publication
(10) Pub. No.: US 2010/0185723 A1
(43) Pub. Date: Jul. 22, 2010

(54) Method for a Server Apparatus for Providing a Display Specification to a Client Apparatus, Computer Program Therefor, and Data Carrier Therewith

(75) Inventor: Pepijn Santcroos, Amsterdam (NL)

Correspondence Address: THE WEBB LAW FIRM, P.C., 700 KOPPERS BUILDING, 436 SEVENTH AVENUE, PITTSBURGH, PA, 15219, US

(73) Assignees: Pepijn Santcroos, Amsterdam (NL); Olive Tree N.V.

(21) Appl. No.: 12/357,829

(22) Filed: Jan. 22, 2009

(51) Int. Cl. G06F 15/173

(52) U.S. Cl. 709/203

(57) ABSTRACT

In response to a server receiving a request for content to be displayed from a client, the server sends a specification of the content to be displayed to the client. The specification includes a definition of a main display area and a definition of at least one additional display area. The definitions of the main and additional display area have associated with them an address of a web page to be displayed in the corresponding area.

### BACKGROUND OF THE INVENTION

1. Field of the Invention

The present invention relates to a method for a server apparatus for providing a display specification to a client apparatus.

The invention further relates to a computer program therefor.

The invention also relates to a data carrier therewith.

2. Description of Related Art

The first web browsers were single window browsers, wherein the browser provided a single window, wherein a single web page could be shown. In order to browse multiple web sites or multiple pages simultaneously, the user was required to launch additional instances of the browser program.

Modern web browsers all support tabbed web browsing, wherein a single window allows for different web sites or web page to be browsed by means of tabs that can be clicked to switch among the web sites or web pages.

A disadvantage of the prior art browsers is, that although several windows can be arranged next to each other, a user needs to arrange the windows all over again, when he has restarted the computer.

### SUMMARY OF THE INVENTION

An object of the present invention is to provide a multi-window browser, wherein a predetermined set of web pages is shown alongside each other when launched.

This object is realised by providing a method for a server apparatus for providing a display specification to a client apparatus for simultaneously showing more than one web site in a web browser run on the client apparatus, comprising the steps of: receiving a request for content to be displayed from the client apparatus; sending a specification of content to be displayed to the client apparatus, wherein the specification comprises a definition of a main display area and a definition of at least one additional display area, wherein the definitions of the main and additional display areas have associated with them an address of a web page to be displayed in the corresponding area.

An advantage of this method is that users themselves are not required to download another web browser, but can continue to use their favourite browser, which can be any (X)HTML-compliant browser.

The method is run on a server in conjunction with a web server. A user types the address of the web server on his personal computer in his favourite browser. After receiving the request for the web page, the web server returns a page description, wherein the display is subdivided in a main display area and additional display areas. For each display area, the server specifies a web address of a web page to be shown in the corresponding display area. The subdivision is realised in one particular embodiment by using HTML framesets. In another embodiment the HTML-tag “object” is used for showing the content of the web address associated with the display area.

In another aspect of the invention, a method is provided, wherein the request comprises an identification, the method further comprising the step of: retrieving from a database an indication of a display area and a web address associated with the display area, using the identification as a key; and wherein the specification of content sent to the client apparatus comprises the definition of the display area, the web address and their association.

In again another aspect of the invention, a method is provided, wherein the identification uniquely identifies a user.

The identification allows for the personalisation of the web pages initially shown in the display areas. This way, the user is initially presented with his favourite web pages, for example his webmail, a news site, a social networking site, and his favourite sports team.

In a further embodiment, the personalisation also allows the user to define the actual layout of the display areas. In again a further embodiment, the user can pick his favourite websites from a list of favourites, to quickly browse to the website without typing the address.

The present invention also provides a method, wherein the specification of content further comprises a definition of at least one control, to be displayed by the client apparatus along with the display areas.

In a further aspect, the present invention provides a method, wherein associated with the control is executable code for swapping the content of the main display area and one of the additional display areas in the web browser of the client apparatus. In one specific embodiment, the additional display areas only provide a limited set of navigational functions, such as following a link, filing in and submitting forms, and browsing back to previous pages. When the user wants to do some more extensive things on a web page shown in one of the additional display areas, clicking the swap control will swap the content of the additional display area to the main display area allowing him to have the web page shown in the main display area, such that the web page is rendered in a larger area. In this specific embodiment, the main display area supports full navigation support, including, for example, bookmarking pages, extensive browsing history, etc.

The present invention also provides a method, wherein the control is a text entry field, and associated with the control is executable code for displaying in the main display area the content of a web page defined by a web address entered in the text entry field.

This method allows the user to type in the address of a web page he wishes to visit. The web page is shown in the main display area.

According to another aspect of the invention, a method is provided, wherein associated with the control is executable code for displaying the content of a previously visited web address in the main display area. This implements the functionality of a Back-button as known from basically all browsers, but according to the method according to the invention, this Back-button only affects the main display area, instead of the whole browser window.

In one preferred method according to the invention the additional display areas are substantially smaller than the main display area.

According to another aspect of the present invention, a method is provided, wherein the height and width of the additional display areas are approximately one third of the height and width of the main display area.

According to again another aspect of the present invention, a method is provided, wherein three additional displays areas are displayed to the left or the right of the main display area. With the emergence of wide screen displays, and web sites still being optimised for traditional 4 3-screens, the method of the present invention is particularly well suited for displaying such web sites optimised for 4 3-screens in a main display area on a wide screen display, with alongside three smaller additional web pages.

The smaller additional sites are particularly well suited for displaying web pages optimised for displaying on mobile devices, such as the mobile version of the web site of the BBC.

In one embodiment, the present invention provides a computer program that, when executed on a processor, performs any of the above methods.

Alternatively, the present invention provides a computer program for browsing the Internet, comprising: display means for displaying a mean display area and at least one additional display area, wherein the additional display area is substantially smaller than the main area; retrieval means for retrieving a web address and an association between the web address and a display area; content retrieval means for retrieving the content of a web page; wherein the computer program initially retrieves the web address and the association, the content of the web page defined by the web address, and displays the content of the web page in the display area associated with the web address. This provides a stand-alone web browser for simultaneously browsing multiple web sites.

The present invention further provides a computer program, further comprising: selection means for selecting an additional display area; display area swapping means for swapping the content of an additional display area that is selected by the selection means, with the content of the main display area.

In a further embodiment, a computer program is provided, further comprising a control, that, when operated, causes the main display area to display the previously displayed web page.

The present invention also provides a computer program, further comprising a text entry field, for entering a web address, wherein the computer program retrieves the web content of the entered web address and displays the retrieved content in the main display area.

In a further embodiment the invention provides a computer program, wherein the height and width of the additional display areas are approximately one third of the height and width of the main display area.

The invention also provides a computer program, wherein three additional display areas are displayed to the left or right of the main display area.

In another embodiment, a data carrier is provided comprising a computer program as mentioned above.

### BRIEF DESCRIPTION OF THE DRAWINGS

Further embodiments and advantages will be shown with reference to the appended figures, wherein:

FIG. 1 shows a system wherein a method according to the present invention can be applied; and

FIG. 2 shows an example browser window resulting from the use of a method according to the present invention.

### DESCRIPTION OF THE PREFERRED EMBODIMENTS

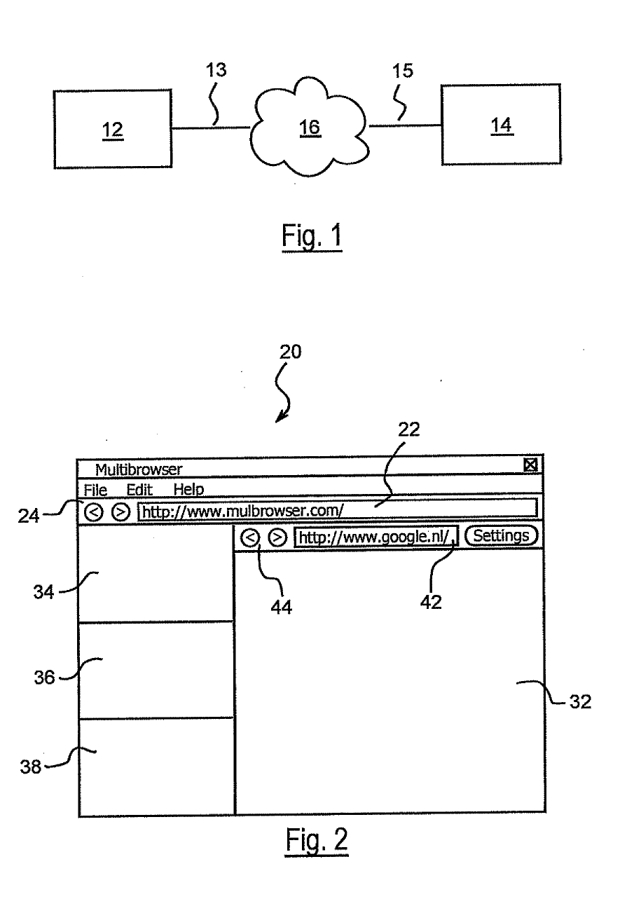

A method according to the invention is run on an internet server 12 (FIG. 1) connected through a network connection 13 to the Internet 16. A user uses a personal computer 14 that is connected through an internet connection 15 to the Internet, to request a page from the internet server 12 by means of a web browser.

The web browser is represented on the display by a browser window 20 (FIG. 2). The browser window 20 comprises known controls such as an address bar 22 for entering a web address, and a back button 24 for navigating back to the previous web page.

By entering a web address of the web server 12 in the address bar 22, a page request is sent by the computer 14 through the Internet 16 to the web server 12. The web server 12 responds by sending a page back to the computer 16 through the Internet 16.

The page sent by the web server 12 comprises a specification of a page layout comprising multiple display areas. The web browser renders the page by displaying, in accordance with the specified page layout, main display area 32, and additional display areas 34, 36, and 38. The first display area 32 shows a first web page, for example the front page of a search engine. A first additional display area 34 shows a second web page, for example, a webmail interface for the e-mail of the user. A second additional display area 36 shows a third web page, for example a news site, and a third additional display area 38 shows a fourth web page, for example the user's profile page of a social networking site. The main display area 32 further comprises additional controls, for example for navigation. An address bar 42 is provided for entering the web address of a web page to be shown in the main display area 32. Furthermore, a back-button 44 is provided in order to have the main display area 32 navigate back to a previously visited page.

It should be noted that the above mentioned embodiments only serve as examples and are not to be taken is limiting the present invention. Many modifications and adaptations of the embodiments shown are possible without departing from the scope of the present invention. For example, embodiments shown can be combined to obtain further embodiments according to the invention. The protection sought is defined by the appended claims.

1. A method for a server apparatus for providing a display specification to a client apparatus for simultaneously showing more than one web site in a web browser run on the client apparatus, the method comprising:
receiving a request for content to be displayed from the client apparatus;
sending a specification of content to be displayed to the client apparatus, wherein the specification comprises a definition of a main display area and a definition of at least one additional display area, wherein the definitions of the main and additional display areas have associated with them an address of a web page to be displayed in the corresponding area.

2. The method according to claim 1, wherein the request comprises an identification, the method further comprising:
retrieving from a database an indication of a display area and a web address associated with the display area, using the identification as a key; and
wherein the specification of content sent to the client apparatus comprises the definition of the display area, the web address and their association.

3. The method according to claim 2, wherein the identification uniquely identifies a user.

4. The method according to claim 1, wherein the specification of content further comprises a definition of at least one control to be displayed by the client apparatus along with the display areas.

5. The method according to claim 4, wherein associated with the control is executable code for swapping the content of the main display area and one of the additional display areas in the web browser of the client apparatus.

6. The method according to claim 4, wherein the control is a text entry field, and associated with the control is executable code for displaying in the main display area the content of a web page defined by a web address entered in the text entry field.

7. The method according to claim 4, wherein associated with the control is executable code for displaying the content of a previously visited web address in the main display area.

8. The method according to claim 1, wherein the additional display areas are substantially smaller than the main display area.

9. The method according to claim 8, wherein the height and width of the additional display areas are approximately one third of the height and width of the main display area.

10. The method according to claim 8, wherein three additional displays areas are displayed to the left or the right of the main display area.

11. A computer program that, when executed on a processor, performs a method according to claim 1.

12. A computer program for browsing the Internet comprising:
display means for displaying a mean display area and at least one additional display area, wherein the additional display area is substantially smaller than the main area;
retrieval means for retrieving a web address and an association between the web address and a display area;
content retrieval means for retrieving the content of a web page;
wherein the computer program initially retrieves the web address and the association, the content of the web page defined by the web address, and displays the content of the web page in the display area associated with the web address.

13. The computer program according to claim 12, further comprising:
selection means for selecting an additional display area;
display area swapping means for swapping the content of an additional display area that is selected by the selection means with the content of the main display area.

14. The computer program according to claim 12, further comprising a control, that, when operated, causes the main display area to display the previously displayed web page.

15. The computer program according to claim 12, further comprising a text entry field for entering a web address, wherein the computer program retrieves the web content of the entered web address and displays the retrieved content in the main display area.

16. The computer program according to claim 12, wherein the height and width of the additional display areas are approximately one third of the height and width of the main display area.

17. The computer program according to claim 12, wherein three additional display areas are displayed to the left or right of the main display area.

18. A data carrier comprising a computer program according to claim 12.
